(19) United States
(12) Patent Application Publication
(10) Pub. No.: US 2004/0229154 A1
(43) Pub. Date: Nov. 18, 2004

(54) Stimulable phosphor, radiation image conversion panel and preparation process thereof

(75) Inventors: Takehiko Shoji, Tokyo (JP); Natsuki Kasai, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA MEDICAL & GRAPHIC, INC.

(21) Appl. No.: 10/841,622

(22) Filed: May 10, 2004

(30) Foreign Application Priority Data
May 13, 2003 (JP) JP2003-134277
May 20, 2003 (JP) JP2003-141758

(51) Int. Cl. G03C 5/16

(52) U.S. Cl. 430/139

(57) ABSTRACT

A preparation process of a stimulable phosphor which exhibits no deterioration in radiographic performance due to moisture absorption and are usable in a viable state over a long period of time is disclosed, wherein after subjected to calcination, phosphor particles are coated with a fluorine-containing compound and a silane coupling agent. A radiation image conversion panel containing the stimulable phosphor is also disclosed.

### FIELD OF THE INVENTION

The present invention relates to a stimulable phosphor, a radiation image (also referred to as radiographic image) conversion panel by the use thereof and in particular a stimulable phosphor and a radiation image conversion panel with no deterioration in performance due to moisture absorption and usable in a viable state without variations in performance over a long period of time.

### BACKGROUND OF THE INVENTION

Radiographic images such as X-ray images are frequently employed for use in medical diagnosis. To obtain such X-ray images, radiography is employed, in which X-rays transmitted through an object are irradiated onto a phosphor layer (so-called fluorescent screen), thereby producing visible light, which exposes silver salt photographic film and the thus exposed film is developed in such a manner similar to that conducted in conventional photography. Recently, there has been introduced a technique of reading images directly from the phosphor layer, without using the silver salt photographic film.

As such a technique, there is known a method, in which radiation transmitted through an object is allowed to be absorbed by a phosphor, followed by exciting the phosphor with light or thermal energy to release radiation energy stored therein as fluorescent light emission, and the emitted fluorescent light is detected to form images. Exemplarily, a radiation image (also referred to as radiographic image) conversion method using stimulable phosphors is known, as described in U.S. Pat. No. 3,859,527 and JP-A No. 55-12144 (hereinafter, the term, JP-A refers to an unexamined Japanese Patent Application Publication).

In this method, a radiation image conversion panel containing a stimulable phosphor is employed. Thus, a stimulable phosphor layer of the radiation image conversion panel is exposed to radiation transmitted through an object to store radiation energies corresponding to respective portions of the object, followed by sequentially exciting the stimulable phosphor with an electromagnetic wave such as visible light or infrared rays (hereinafter referred to as “stimulating rays”) to release the radiation energy stored in the phosphor as light emission (stimulated emission), photo-electrically detecting the emitted light to obtain electric signals, and reproducing the radiation image of the object as a visible image from the electrical signals on a recording material such as photographic film or a CRT.

The foregoing radiation image recording and reproducing method has an advantage in that radiation images having abundant information content can be at a low exposure dose relative to conventional radiography using the combination of a conventional radiographic film and intensifying screen.

Stimulable phosphors are phosphor material that, after having been exposed to radiation rays, causes stimulated emission by exposing to stimulating rays. Phosphors capable of causing stimulated emission at a wavelength of 400 to 900 nm with a stimulating ray of 400 to 900 nm are generally applied to practical use.

Examples of the stimulable phosphor used in the radiation image conversion panel include,

(1) a rare earth activated alkaline earth metal fluorohalide phosphor represented by the formula of (Ba₁₋ₓ, M²⁺x)FX:yA, as described in JP-A No. 55-12145, in which M²⁺ is at least one of Mg, Ca, Sr, Zn and Cd; X is at least one of Cl, Br and I; A is at least one of Eu, Tb, Ce, Tm, Dy, Pr, Ho, Nd, Yb, and Er; x and y are numbers meeting the conditions of 0≦x≦0.6 and 0≦y≦0.2; and the phosphor may contain the following additives:

X′, BeX″ and M³X₃′″, as described in JP-A No. 56-74175 (in which X′, X″ and X′″ are respectively at least a halogen atom selected from the group of Cl, Br and I; and M³ is a trivalent metal);

a metal oxide described in JP-A No. 55-160078, such as BeO, BgO, CaO, SrO, BaO, ZnO, Al₂O₃, Y₂O₃, La₂O₃, In₂O₃, SiO₂, TiO₂, ZrO₂, GeO₂, SnO₂, Nb₂O₅ or ThO₂;

Zr and Sc described in JP-A No. 56-116777;

B described in JP-A No. 57-23673;

As and Si described in JP-A No. 57-23675;

M. L (in which M is an alkali metal selected from the group of Li, Na, K, Rb and Cs; L is a trivalent metal Sc, Y, La, Ce, Pr, Nd, Pm, Sm, Gd, Tb, Dy, Ho, Er, Tm, Yb, Lu, Al, Ga, In, and Tl) described in JP-A 58-206678;

calcined tetrafluoroboric acid compound described in JP-A No. 59-27980;

calcined, univalent or divalent metal salt of hexafluorosilic acid, hexafluorotitanic acid or hexafluorozirconic acid described in JP-A No. 59-27289;

NaX′ described in JP-A No. 59-56479 (in which X′ is at least one of Cl, Br and I);

a transition metal such as V, Cr, Mn, Fe, Co or Ni, as described in JP-A No. 59-56479;

M¹X′, M′²X″, M³X′″ and A, as described in JP-A No. 59-75200 (in which M¹ is an alkali metal selected from the group of Li, Na, K, Rb and Cs; M′² is a divalent metal selected from the group of Be and Mg; M³ is a trivalent metal selected from the group Al, Ga, In and Tl; A is a metal oxide; X′, X″ and X′″ are respectively a halogen atom selected from the group of F, Cl, Br and I);M¹X′ described in JP-A No. 60-101173 (in which M¹ is an alkali metal selected from the group of Rb and Cs; and X′ is a halogen atom selected from the group of F, Cl, Br and I);

M²′X′₂·M²′X″₂ (in which M²′ is at least an alkaline earth metal selected from the group Ba, Sr and Ca; X′ and X″ are respectively a halogen atom selected from the group of Cl, Br and I, and X′≠X″); and

LnX″₃ described in JP-A No. 61-264084 (in which Ln is a rare earth selected from the group of Sc, Y, La, Ce, Pr, Nd, Pm, Sm, Gd, Tb, Dy, Ho, Er, Tm, Yb and Lu; X″ is a halogen atom selected from the group of F, Cl, Br and I);

(2) a divalent europium activated alkaline earth metal halide phosphor described in JP-A No. 60-84381, represented by the formula of M²X₂·aM²′₂:xEu²⁺ (in which M² is an alkaline earth metal selected from the group of Ba, Sr and Ca; X and X′ is a halogen atom selected from the group of Cl, Br and I and X≠X′; a and x are respectively numbers meeting the requirements of 0≦a≦0.1 and 0<x<0.2);

the phosphor may contain the following additives;

M¹X″ described in JP-A No. 60-166379 (in which M¹ is an alkali metal selected from the group of Rb, and Cs; X″ is a halogen atom selected from the group of F, Cl, Br and I;

KX″, MgX₂′″ and M³X₃″″ described in JP-A No. 221483 (in which M³ is a trivalent metal selected from the group of Sc, Y, La, Gd and Lu; X″, X′″ and X″″ are respectively a halogen atom selected from the group of F, Cl Br and I;

B described in JP-A No. 60-228592;

an oxide such as SiO₂ or P₂O₅ described in JP-A No. 60-228593;

LiX″ and NaX″ (in which X″ is a halogen atom selected from the group of F, Cl, Br and I;

SiO₂ described in JP-A No. 61-120883;

SnX₂″ described in JP-A 61-120885 (in which X″ is a halogen atom selected from the group of F, Cl, Br and I;

CsX″ and SnX₂′41 described in JP-A No. 61-235486 (in which X″ and X′″ are respectively a halogen atom selected from the group of F, Cl, Br and I;

CsX″ and Ln³⁺ described in JP-A 61-235487 (in which X″ is a halogen atom selected from the group of F, Cl, Br and I; Ln is a rare earth element selected from the group of Sc, Y, Ce, Pr, Nd, Sm, Gd, Tb, Dy, Ho, Er, Tm, Yb and Lu;

(3) a rare earth element activated rare earth oxyhalide phosphor represented by the formula of LnOX:xA, as described in JP-A No. 55-12144 (in which Ln is at least one of La, Y, Gd and Lu; A is at least one of Ce and Tb; and x is a number meeting the following condition, 0<x<0.1);

(4) a cerium activated trivalent metal oxyhalide phosphor represented by the formula of M(II)OX:xCe, as described in JP-A No. 58-69281 (in which M(II) is an oxidized metal selected from the group of Pr, Nd, Pm, Sm, Eu, Tb, Dy, Ho, Er, Tm, Yb and Bi; X is a halogen atom selected from the group of Cl, Br and I; x is a number meeting the following condition, 0<x<0.1;

(5) a bismuth activated alkali metal halide phosphor represented by the formula of M(I)X:xBi, as described in JP-A No.62-25189 (in which M(I) is an alkali metal selected from the group of Rb and Cs; X is a halogen atom selected from the group of Cl, Br and I; x is a number meeting the following condition, 0<x<0.2;

(6) a divalent europium activated alkaline earth metal halophosphate phosphor represented by the formula of M(II)₅(PO₄)₃X:xEu²⁺, as described in JP-A No. 60-141783 (in which M(II) is an alkaline earth metal selected from the group of Ca, Sr and Ba; X is a halogen atom selected from the group of F, Cl, Br and I; x is a number meeting the following condition, 0<x<0.2);

(7) a divalent europium activated alkaline earth metal haloborate phosphor represented by the formula of M(II)₂BO₃X:xEu2+, as described in JP-A No. 60 157099 (in which M(II) is an alkaline earth metal selected from the group of Ca, Sr and Ba; X is a halogen atom selected from the group of Cl, Br and I; x is a number meeting the following condition, 0<x≦0.2);

(8) a divalent europium activated alkaline earth metal halophosphate phosphor represented by the formula of M(II)₂PO₄X:xEu²⁺, as described in JP-A No. 60-157100 (in which M(II) is an alkaline earth metal selected from the group of Ca, Sr and Ba; X is a halogen atom selected from the group of Cl, Br and I; x is a number meeting the following condition, 0<x≦0.2);

(9) a divalent europium activated alkaline earth metal hydrogenated halide phosphor represented by the formula of M(II)HX:xEu²⁺, as described in JP-A No. 60-217354 (in which M(II) is an alkaline earth metal selected from the group of Ca, Sr and Ba; X is a halogen atom selected from the group of Cl, Br and I; x is a number meeting the following condition, 0<x≦0.2);

(10) a cerium activated rare earth complex halide phosphor represented by the formula of LnX₃·aLn′X₃′:xCe³⁺, as described in JP-A No. 61-21173 (in which Ln and Ln′ are individually a rare earth element selected from the group of Y, La, Gd and Lu; X and X′ are respectively a halogen atom selected from the group of F, Cl, Br and I and X≠X′; a and x are respectively numbers meeting the following conditions, 0.1<a≦10.0 and 0<x≦0.2;

(11) a cerium activated rare earth complex halide phosphor represented by the formula of LnX₃·aM(I)X′:xCe³⁺, as described in JP-A 61-21182 (in which Ln and Ln′ are respectively a rare earth element selected from the group of Y, La, Gd and Lu; M(I) is an alkali metal selected from the group of Li, Na, k, Cs and Rb; X and X′ are respectively a halogen atom selected from the group of Cl, Br and I; a and x are respectively numbers meeting the following conditions, 0.1<a≦10.0 and 0<x≦0.2;

(12) a cerium activated rare earth halophosphate phosphor represented by the formula of LnPO₄·aLnX₃:xCe³⁺, as described in JP-A No. 61-40390 (in which Ln is a rare earth element selected from the group of Y, La, Gd and Lu; X is a halogen atom selected from the group of F, Cl, Br and I; a and x are respectively numbers meeting the following conditions, 0.1<a≦10.0 and 0<x≦0.2;

(13) a divalent europium activated cesium rubidium halide phosphor represented by the formula of CsX:aRbX′ :xEu²⁺, as described in JP-A No. 61-236888 (in which X and X′ are individually a halogen atom selected from the group of Cl, Br and I; a and x are respectively numbers meeting the following conditions, 0.1<a≦10.0 and 0<x≦0.2;

(14) a divalent europium activated complex halide phosphor represented by the formula of M(II)X₂·aM(I)X′:xEu²⁺, as described in JP-A No. 61-236890 (in which M(II) is an alkaline earth metal selected from the group of Ba, Sr and Ca; M(I) is an alkali metal selected from the group of Li, Rb and Cs; X and X′ are respectively a halogen atom selected from the group of Cl, Br and I; a and x are respectively numbers meeting the following conditions, 0.1<a≦20.0 and 0<x≦0.2.

Of the foregoing stimulable phosphors, an iodide-containing divalent europium activated alkaline earth metal fluorohalide phosphor, ibdide-containing divalent europium activated alkaline earth metal halide phosphor, iodide-containing rare earth element activated rare earth oxyhalide phosphor and iodide-containing bismuth activated alkali metal halide phosphor exhibit stimulated emission having relatively high luminance.

Radiation image conversion panels using these stimulable phosphors, after storing radiation image information, release stored energy by scanning with stimulating light so that after scanning, radiation images can be again stored and the panel can be used repeatedly. In conventional radiography, a radiographic film is consumed for each photographing exposure; in the radiation image conversion method, however, the radiation image conversion panel is repeatedly used, which is advantageous in terms of natural resource conservation and economic efficiency.

It is therefore desirable to provide performance capable of withstanding for the use over a long period of time, without deteriorating radiation image quality, to the radiation image conversion panel. However, in general, stimulable phosphors used in the radiation image conversion panel are so hygroscopic that when allowed to stand in a room under usual climatic conditions, the phosphor absorbs atmospheric moisture and is deteriorated over an elapse of time. Exemplarily, when the stimulable phosphor is allowed to stand under high humidity, radiation sensitivity is lowered along with an increase in absorbed moisture content. In general, radiation latent images recorded onto the stimulable phosphor, after being exposed to radiation rays, regress over an elapse of time and the period between exposure to radiation rays and the phosphor exhibits such behavior that scanning with stimulating light requires longer time, the intensity of reproduced radiation image signal becomes less, so that moisture absorption of the stimulable phosphor accelerates the foregoing latent image regression. Accordingly, the use of a radiation image conversion panel having such a moisture-absorbing stimulable phosphor often lowers reproducibility of reproduced signals at the time of reading radiation images.

To prevent the foregoing deterioration in performance of stimulable phosphor particles due to moisture absorption, there were proposed coating a moisture resistant protective layer or resin film on a phosphor layer to reduce moisture reaching the phosphor layer, the use of a titanate-type coupling agent described in JP-B No. 2-278196 or the use of silicone oil described in JP-B 5-52919. However, none of these proposals led to viable solution.

### SUMMARY OF THE INVENTION

Accordingly, it is an object of the present invention is to provide a stimulable phosphor and a radiation image conversion panel using the stimulable phosphor which exhibit no deterioration in radiographic performance due to moisture absorption and are usable in a viable state over a long period of time.

In one aspect, this invention is directed to a process of preparing stimulable phosphor particles comprising preparing particles of a precursor of the stimulable phosphor, subjecting the particles of the precursor to calcination to obtain stimulable phosphor particles, and coating the stimulable phosphor particles with a fluorine-containing compound and a silane coupling agent.

In another aspect, this invention is directed to a stimulable phosphor comprised of stimulable phosphor particles which are coated with a fluorine-containing compound and a silane coupling agent and which are prepared by the process described above.

In another aspect, this invention is directed to a radiation image conversion panel comprising a support having thereon a phosphor layer containing a binder and stimulable phosphor particles which are prepared by the process described above.

### DETAILED DESCRIPTION OF THE INVENTION

During a course of study of deterioration in sensitivity due to moisture absorption of the stimulable phosphors described in the foregoing (1) to (14), it was found by the inventors of this application that deterioration in performance was caused by deliquescence of the phosphor due to moisture absorption and alteration of the phosphor. Accordingly, even if either the deliquescence or the alteration is prevented, thorough solution is not achieved. Thus, the foregoing problems were solved by the constitution of this invention as a result of extensive study to prevent both of deliquescence and alteration. Deliquescence refers to a phenomenon in which the phosphor absorbs moisture from ambient air, forming an aqueous solution by itself and alteration is a phenomenon in which deliquescence is not caused but fluorescence characteristics of the phosphor are altered by moisture present in ambient air. The mechanism of the alteration is not fully understood but it is assumed to be related to discoloration in the interior of the phosphor particle.

Whereas fluorine-containing compounds usable in this invention are effective to prevent both of deliquescence and alteration, there were defects in which the fluorine-containing compounds were easily peeled off from the phosphor surface in the course of preparation of stimulable phosphor plates, specifically in the processes of preparation of a coating solution, dispersion and coating in which external forces were applied to the phosphor.

It was found by the inventors of this application that the combined use of a silane coupling agent with a fluorine-containing compound led to the fluorine-containing compound strongly acting phosphor particles, thereby reducing troubles caused in the stage of solution making, dispersion and coating and thereby achieving effects of this invention. Specifically, it was proved that the use of mercapto-modified silane coupling agents not only enhanced such an action but also minimized variation in performance of phosphor particles.

Moisture absorption of the phosphor is thought to occur due to various causes including capillary condensation and once water vapor is condensed as water drops between phosphor particles, causing deliquescence and leading to deterioration in performance. Such a phenomenon easily occurred specifically in halogen-containing stimulable phosphor particles. Thus, it is assumed that coating of a fluorine-containing compound and a silane coupling agent effectively prevents occurrence of deliquescence. It was also found that such effects were marked specifically in halogen-containing stimulable phosphors.

Although it was contemplated that coating with fluorine-containing compounds was effective to prevent variation in phosphor performance, it was difficult to form a fluorine-containing compound film directly on the surface of stimulable phosphor particles.

In this invention, a silane coupling agent allows film of a fluorine-containing compound to be strongly bonded to phosphor particles, achieving effects of this invention.

Preferred fluorine-containing compounds usable in this invention include fluorine-containing (or fluorinated) polymers. The fluorine-containing polymer (or fluorinated polymer) is preferably formed of unsaturated ester monomers containing a fluorinated aliphatic group. Thus, such an unsaturated ester monomer is a compound which contains at least a partially fluorinated aliphatic group (preferably at least a partially fluorinated alkyl group) and an ethylenically unsaturated bond. Specifically, an unsaturated ester monomer containing a fluorinated aliphatic group is preferably represented by the following formula:

Rf-Q-O—C (═O)—C (R₁)═CH₂

where Rf is an at least partially fluorinated, straight, branched or cyclic aliphatic group having 2 to 12 carbon atoms (for example, at least partially fluorinated alkyl group and preferably completely fluorinated alkyl group); R₁ is a hydrogen atom or CH₃; Q is a lower alkylene group such as —CH₂— or —CH₂CH₂— or a —SO₂NR₂—(lower alkylene group), i.e., —SO₂NR₂-attached lower alkylene group, such as —SO₂NR₂-CH₂— or —SO₂NR₂-CH₂CH₂—, in which R₂ is a hydrogen atom or a lower alkyl group, such as —CH₃ or —C₂H₅.

The Rf is preferably a fluorinated aliphatic group having 3 to 7 carbon atoms and preferably 3 to 6 carbon atoms. The Rf containing —CF₃ as an end group is preferred in terms of achieving effects of this invention. The Q is a lower alkylene group and preferably —CH₂— or —CH₂CH₂—. Specific examples of the unsaturated ester monomer include: F (CF₂) ₆CH₂OC (═O) C (CH₃)═CH₂, C₇F₁₅-SO₂N (C₂H₅) C₂, c-C₆F₁₁CH₂OC (═O) C (CH₃)═CH₂, C₆F₁₃C₂H₄OC (═O) CH=CH₂, (CF₃)₂CF (CF₂)₂C₂H₄OC (═O) CH═CH₂, H (CF₂) ₄CH₂OC (═O) CH═CH₂, F(CF₂)₄C₂H₄OC(═O)CH═CH₂, AND F(CF₂)₃CH₂OC (═O)CH═CH₂. These monomers can be prepared in accordance with conventional methods, as described in U.S. Pat. Nos. 2,803,615 and 2,841,573.

Further, polymers are cited, which are obtained by allowing a perfluoro-ether having two terminal double bonds to singly radical-polymerize and allowing a perfluoro-ether having two terminal double bonds to radical-polymerize with an other monomer. Such polymers are disclosed, for example, in JP-A Nos. 63-238111 and 63-238115.

Thus, a perfluoro-ether containing two terminal double bonds, e.g., CF₂═CF(CF₂)_{N}—O—(CF₂)ₘCF═CF₂ (n:0-5, m:0-5, m+n: 1-6), is allowed to singly radical-polymerize and a perfluoro-ether containing two terminal double bonds is allowed to radical-copolymerize with a polymerizable other monomer to obtain a cyclopolymerized fluorine-containing polymer. For example, radical polymerization of CF₂═CF—O—CF₂CF═CF₂ forms the following fluorinated polymer having a 5-membered cycle structure in the main chain:

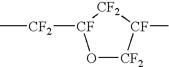

Examples of a monomer co-polymerizable with the perfluoro-ether containing two terminal double bonds include fluoro-olefins such as tetrafluoroethylene, fluoro-vinyl ether such as perfluorovinyl, vinylidene fluoride, vinyl fluoride and chlotriethylene.

As described in JP-B No. 63-18964 (hereinafter, the term, JP-B refers to Japanese Patent publication), a fluorine-containing polymer, for example, is cited, which is comprised of the following monomer:

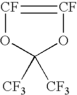

Specifically, there are cited an amorphous copolymer having a monomer unit of perfluoro-2,2-dimethyl-1,3-dioxonol (PDD), as shown above and a monomer unit of tetrafluoroethylene, and an amorphous ternary polymer having the foregoing monomer units and an other ethylenically unsaturated monomer. Examples of an ethylenically unsaturated monomer forming a ternary polymer include olefins such as ethylene and butene, vinyl compounds such as vinyl fluoride and vinylidene fluoride, and perfluoro-compounds such as perfluoropropene.

Preferred examples of commercially available fluorine-containing polymer include Cytop CTX-805 and CTX109A (trade name, available from Asahi Glass Co., Ltd.).

Solvents for the foregoing fluorine-containing polymer include fluorinated solvents, for example, ethers containing hydrogen and fluorine atoms, such as hydrofluoroether (HFE). Useful hydrofluoroethers (HFE) include the following two types:

(1) separate type hydrofluoroether in which a segment such as an ether-bonded alkyl or alkylene is perfluorinated (e.g., perfluorocarbon group) or fluorinated (e.g., hydrocarbon group), therefore, not partial-fluorinated;

(2) ω-hydrofluoroether in which an ether-bonded segment is not fluorinated (e.g., a hydrocarbon group), is perfluorinated (e.g., perfluorocarbon ether group), or is partially fluorinated (e.g., fluorocarbon or hydrofluorocarbon group).

Separate type hydrofluoroethers include a mono-, di- or tri-alkoxy-substituted perfluoroalkane or perfluorocycloalkane, and a perfluoroalkyl-containing or perfluorocycloalkylene-containing perfluoroalkane compound. These HFE compounds are preferably those which are described in WO96/22356, represented by the following formula (1):

formula (1): Rf—(O—Rh)ₓ

where x is an integer of 1 to 3 (preferably 1); Rf is a perfluorinated, straight, branched or cyclic hydrocarbon group having a valence number of x (that is, x-valent) and 6 to 15 carbon atoms; and one or more Rhs are each independently a straight or branched alkyl group having 1 to 3 carbon atoms (preferably 1 or 2 carbon atoms and more preferably methyl). The Rf may contain at least one heteroatom or may contain a terminal F₅S-group. Of the foregoing HFE, one in which Rf contains no heteroatom and no terminal F₅S-group.

Representative examples of the hydrofluoroether compounds represented by the foregoing formula (1) are shown

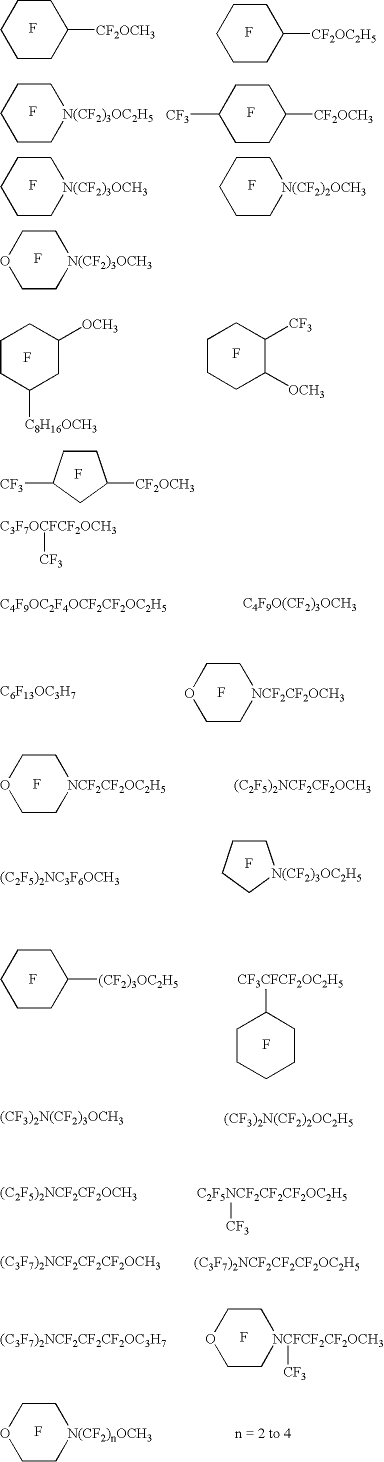

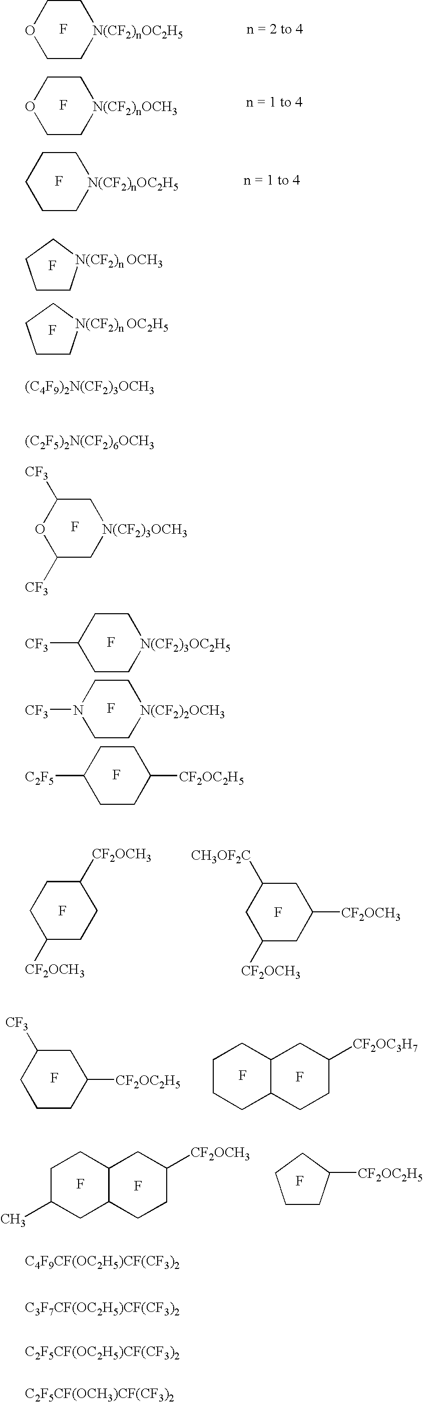

In the foregoing exemplified compounds, the ring structure designated “F” is perfluorinated. The HFE compound may be used alone or as a mixture with another HFE.

Other useful hydrofluoroether compounds include -a hydrofluoroalkyl ether compound represented by the following formula (2):

X—Rf′—(O—Rf″)_{y}—O—R″—H formula (2)

where X is a fluorine or hydrogen atom; Rf′ is a divalent perfluorinated organic group having 1 to 12 carbon atoms; Rf″is a divalent perfluorinated organic group having 1 to 6 carbon atoms; R″ is a divalent organic group having 1 to 6 carbon atoms, which is preferably perfluorinated; y is an integer of 0 to 4, and when X is a fluorine atom and y is 0, R″ contains at least one fluorine atom, provided that the total fluorinated carbon number is at least 6.

Specific examples of the compound represented by the foregoing formula (2) are shown below:

C₄FOC₂F₄H

HC₃F₆OC₃F₆H

C₅F₁₁OC₂F₄H

C₆F₁₃OCF₂H

C₆F₁₃OC₂HF₄

c-C₆F₁₁CF₂OC₂F₄H

HCF₂O(C₂F₄O)ₙ(CF₂O) CF₂H

C₃F₇O{C (CF₃) CF₂O}ₚCFHCF₃

C₄F₈OCF₂C (CF₃)₂CF₂H

HCF₂CF₂OCF₂C (CF₃)₂CF₂OC₂F₄H

C₇F₁₇OCFHCF₃

C₈F₁₀OCF₂O(CF₂)₅H

C₈F10OC₂F₄OC₂F₄OCF₂H

A solvent useful for the coating composition or coating method relating to this invention contains R′″—OC₂H₅, in which R′″ is a straight or branched perfluoro-alkyl group having 6 to 15 carbon atoms and preferably 3-ethoxyperfluoro(2-methylhexane), CF3CF(CF₃) CF (OC₂H₅) C₃F₇.

The foregoing solvent exhibits solvent characteristics equivalent to conventional PFC solvents. Specifically, 3-ethoxyperfluoro-(2-methylhexane) exhibits a surface tension and a viscosity of 1.4×10⁻² N/m and 1.2×10⁻³ Pa·s (at 25° C.), respectively, which are factors determining capabilities of forming thin uniform coating film, and having a high solubility equivalent to PFC for fluorine-containing polymers.

The coating composition can be easily formed by adding a polymer having a fluorine-containing ring structure to hydrofluoroether (HFE) with stirring at room temperature. A solution concentration of the fluorine-containing polymer composition, depending on the kind thereof, is usually 1 to 20% by weight.

According to the coating method relating to this invention, a uniform surface treatment can be achieved due to superior solvent characteristics of HFE, e.g., CF₃CF(CF₃)CF(OC₂H₅), even in such a thin surface treatment. It was further proved that fluorine-containing compounds effectively inhibited tarnishing of stimulable phosphors and the foregoing preferable fluorine-containing compounds exhibited effects of inhibiting sensitivity reduction caused by coloration of the phosphor as well as moisture-proofing. Such an anti-tarnishing effect is marked when a phosphor contains iodine within the structure, and liberated iodine effectively prevents yellowing of a phosphor.

Next, silane coupling agents will be described. Silane coupling agents usable in this invention are not specifically limited but compounds represented by the following formula (1) are preferred:

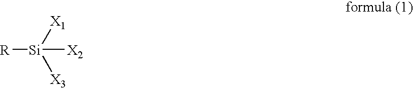

wherein R is an aliphatic or aromatic hydrocarbon group, which may be intervened with an unsaturated group (e.g., vinyl) or may be substituted by R₂OR₃—, R₂COOR₃—, R₂NHR₃— (in which R₂ is an alkyl group or an aryl group, and R₃ is an alkylene group or an arylene group) or other substituents; X₁, X₂ and X₃ are each an aliphatic or aromatic hydrocarbon group, acyl group, amido group, alkoxy group, alkylcarbonyloxy group, epoxy group, mercapto group or a halogen atom, provided that at least one of X₁, X₂ and X₃ is a group other than the hydrocarbon group. X₁, X₂ and X₃ are preferably a group subject to hydrolysis.

Specific examples of the silane coupling agent of formula (I) include methyltrimethoxysilane, methyltriethoxysilane, vinyltriacetoxysilane, vinyltrichlorosilane, vinyltriethoxysilane, γ-chloropropyltrimethoxysilane, γ-chloropropylmethyldichlorosilane, γ-chloropropyl-methyldimethoxysilane, γ-chloropropylmethyldiethoxysilane, γ-aminopropyltriethoxysilane, N—(β-aminoethyl)-γ-aminopropyl-trimethoxysilane, N—(β-aminoethyl)-γ-aminopropylmethyl-dimethoxysilane, γ-mercaptopropyltrimethoxysilane, γ-mercaptopropylmethyldimethoxysilane, γ-glycidoxypropyl-trimethoxysilane, γ-methacryloxypropyltrimethoxysilane, γ-methacryloxypropylmethyldimethoxysilane, γ-(2-amonoethyl)-aminopropyltrimethoxysilane, γ-isocyanatepropyltriethoxy-silane, γ-(2-aminoethyl)aminopropylmethyldimethoxysilane, γ-anilinopropyltrimethoxysilane, vinyltrimethoxysilane, and N-β-(N-vinylbenzylaminoethyl)-γ-aminopropyltrimethoxy-silane·hydrochloric acid salt or aminoslane composite. Of these, vinyl type, mercapto type, glycidoxy type and methacryloxy type are preferred. In the embodiments of this invention, the silane coupling agent preferably contains a mercapto group, such as γ-mercaptopropyltrimethoxysilane and 65 -mercaptopropylmethyldimethoxysilane.

Coating stimulable phosphor particles relating with the foregoing fluorine-containing compound and silane coupling agent can be conducted according to commonly known methods. There are known, for example, a dry method in which a fluorine-containing compound and a silane coupling agent are dropwise added or sprayed onto stimulable phosphor particles with stirring by a Henschel mixer; a slurry method in which a fluorine-containing compound and a silane coupling agent are dropwise added to slurry-form stimulable phosphor particles with stirring and after completion of the addition, the phosphor is allowed to precipitate and filtered, and then dried to remove remaining solvent; a method in which a stimulable phosphor is dispersed in a solvent and after adding a fluorine-containing compound and a silane coupling agent thereto with stirring, the solvent is evaporated to form a deposited layer; and a method of adding a fluorine-containing compound and a silane coupling agent to a coating dispersion of a stimulable phosphor. Drying the fluorine-containing compound and the silane coupling agent is carried out preferably at a temperature of 60 to 130° C. for 10 to 200 min. to definitely undergo the reaction.

Further, examples of a surface treatment of stimulable phosphor particles include a method in which phosphor particles, immediately after calcination, are pulverized in a dispersion solution of a fluorine-containing compound and a silane coupling agent to subject the phosphor particles to a surface treatment, followed by filtration and drying; and a method in which a fluorine-containing compound and a silane coupling agent are added to a coating dispersion of a stimulable phosphor.

A fluorine-containing compound is preferably contained in an amount of 0.2 to 20% by weight, based on stimulable phosphor. A fluorine-containing compound in an amount of more than 20% of the phosphor results in reduced sensitivity and hardened coating film, leading to cracking, and an amount less than 0.2% results in halved effects of the invention.

A silane coupling agent is preferably contained in an amount of 0.2 to 20% by weight, based on stimulable phosphor. A silane coupling agent in an amount of more than 20% of the phosphor results in reduced sensitivity and hardened coating film, leading to cracking, and an amount less than 0.2% results in halved effects of the invention.

A surface treatment of phosphor particles with a fluorine-containing compound and a silane coupling agent leads to stimulable phosphor particles improved in moisture resistance and the thus enhanced moisture resistance is maintained even after coated as a phosphor layer on a support through dispersion and solution making and coating.

It has not been definitely clarified the reason why the surface treatment of phosphor particles with a fluorine-containing compound and a silane coupling agent inhibited peeling of the fluorine-containing compound from the phosphor particles, but it is assumed that there may be formed a bond between the phosphor particles and the fluorine-containing particles. Accordingly, a total silane coupling agent amount of not more than 10% minimizes reduction of sensitivity and an amount of not less than 0.2% results in enhanced effects of this invention.

During a course of studying prevention of the foregoing deterioration due to moisture absorption, it was proved that coating phosphor particles with particulate metal oxide, followed by treatment with a fluorine-containing compound and a silane coupling agent prevented deliquescence and alteration of the phosphor.

It is supposed that coating phosphor precursor particles with particulate metal oxide particles and subsequent calcination thereof, followed by a surface treatment of the calcined phosphor particles by a silane coupling agent leads to formation of a silicon-containing coat with a silane coupling agent so as to fill in portions surrounding metal oxide particles dispersed on the phosphor particles to form a continuous phase.

On the other hand, even when phosphor precursor particles with no coverage of particulate metal oxide was calcined, followed by coating with particulate metal oxide and a surface treatment by a silane coupling agent, phosphor particles exhibiting high moisture resistance were obtained. However, there occurred a phenomenon that when the thus prepared phosphor particles were coated, as a phosphor layer, on a support through stages of dispersion, solution preparation and coating, the effect of enhanced moisture resistance was reduced by half. Such a phenomenon is attributed to the particulate metal oxide being peeled from the phosphor particles. The calcined phosphor particles are supposed to be bonded to the fine metal oxide particle by an electrical force and a stronger force than this electrical force acts thereon during the stage of dispersion, solution preparation and coating, causing peeling.

In one preferred embodiment of this invention, phosphor precursor particles are coated with a particulate metal oxide and then calcined, and the calcined phosphor particles are subjected to a surface treatment with a fluorine-containing compound and a silane coupling agent, and thereby, stimulable phosphor particles exhibiting enhanced moisture resistance were obtained and even when coated on the support in the form of a phosphor layer, the enhanced moisture resistance of the phosphor particles was maintained. However, an excessive amount of the metal oxide results in reduced calcination efficiency, leading to a stimulable phosphor with deteriorated emission characteristics. In such a case, the amount of the first metal oxide is determined within the range giving no adverse effect on the calcination efficiency and after completion of calcination, the phosphor particles are coated with a second particulate metal and further subjected to a surface treatment with a fluorine-containing compound and a silane coupling agent, thereby achieving enhanced effects of this invention. The reason for the particulate metal oxide being not peeled from the phosphor particles in the stage of dispersion, solution making and coating is not clarified but it is assumed that a bond may be formed between the phosphor particles and the particulate metal oxide.

The first metal oxide is preferably alumina in terms of prevention of sintering of phosphor particles. Alumina is coated in an amount of 0.01 to 2.0% by weight, based on phosphor particles. When alumina is used as a first metal oxide, the use of silica as a second metal oxide results in enhanced moisture resistance. The reason for enhanced moisture resistance by the use of silica is not clarified but it is assumed that silica, which differs in electrostatic property from alumina, acts a strong electric force on the particulate alumina secured on the phosphor particle surface.

The particulate metal oxide usable in this invention preferably has an average particle size of 2 to 50 nm. An average size of less than 2 nm is difficult to be industrially available and an average size of more than 50 nm makes it difficult to coat the particulate metal oxide on the phosphor particle surface. The average size is an average value of sizes of 100 particles, which are determined electron microscopically. The total metal oxide amount is preferably 0.01 to 10% by weight based on stimulable phosphor precursor. A total amount of more than 10.0% by weight results in reduced sensitivity and a total amount of less than 0.01% by weight leads to halved effects of the invention.

Stimulable phosphors usable in this invention are preferably a rare earth activated alkaline earth metal fluorohalide phosphor, represented by the following general formula (I):

(Ba₁₋ₓM¹ₓ)FX:yM², zLn formula (I)

wherein M¹ is at least one alkaline earth metal selected from the group consisting of Mg, Ca, Sr, Zn and Cd; M² is at least one alkali metal atom selected from the group consisting of Li, Na, K, Rb and Cs; X is at least one halogen atom selected from the group consisting of Cl, Br and I; Ln is at least one rare earth element selected from the group consisting of Ce, Pr, Sm, Eu, Gd, Tb, Tm, Dy, Ho, Nd, Er and Yb; x, y and z are respectively 0≦x≦0.6, 0≦y≦0.05 and 0≦z≦0.2.

The stimulable phosphor particles may be in any form, including tabular grains, spherical particles and hexahedral particles.

A precursor of the stimulable phosphor (hereinafter, also denoted as a stimulable phosphor precursor), which has been prepared in a liquid phase synthesis process, is preferably used in this invention. In the liquid phase synthesis process, the form or particle size of a stimulable phosphor precursor can be easily controlled by adjustment of the saturated concentration of the reaction solution system. For example, JP-A No. 7-233369 discloses a method of preparing a tetradecahedral stimulable phosphor in the liquid phase process. It is also preferred to prepare tabular particles having a relative high aspect ratio employing a liquid phase process. The preparation of a stimulable phosphor precursor in the liquid phase process can employ the preparation method described in JP-A No. 10-140148 and a phosphor precursor preparation apparatus described in JP-A No. 10-147778. The stimulable phosphor precursor refers to a material represented by the foregoing formula (1) in a state of having not been subjected to a temperature higher than 600° C. (i.e., calcination), and the stimulable phosphor precursor emitting neither stimulated emission nor instantaneous emission.

In this invention, the stimulable phosphor precursor is preferably prepared by the liquid phase synthesis method, as described below. Thus, the preparation method of the precursor comprises the steps of:

preparing within a reaction vessel an aqueous mother liquor containing at least 1.6 mol/l BaI₂ (preferably, at least 3.5mol/l BaI₂) and a halide of Ln, provided that when “a” of the formula (1) is not zero, the mother liquor further contains a halide of M¹,

adding an aqueous solution containing a 6 mol/l or more (preferably not less than 8 mol/l) inorganic fluoride (preferably, ammonium fluoride or alkali metal fluoride) into the mother liquor, while maintaining the mother liquor at 50° C. or more (preferably, 80° C. or more) to form a crystalline precipitate of a stimulable phosphor precursor, and separating the crystalline precipitate of the precursor from the mother liquor.

The thus prepared stimulable phosphor precursor is further subjected to calcination, thereby exhibiting stimulated emission and instantaneous emission.

The stimulable phosphor precursor is preferably subjected to the following calcination processes to prepare a stimulable phosphor. The process comprises the steps of:

heating the stimulable phosphor precursor to a temperature of 600°0 C., while exposing the stimulable phosphor precursor to a weakly reducing atmosphere containing oxygen of less than 100 ppm, then

introducing oxygen into the reducing atmosphere so that oxygen is at least 100 ppm and the percentage by volume of oxygen is less than that of the reducing component, based on the total atmosphere volume , and holding the stimulable phosphor precursor therein for a period of at least 1 min., and then

turning back the atmosphere and holding the stimulable phosphor precursor in a weakly reducing atmosphere containing less than 1000 ppm (preferably less than 100 ppm) of oxygen for a period of at least 30 min., while maintaining a temperature at not less than 600° C., and thereafter cooling to a temperature of not more than 100° C., while maintaining a weakly reducing atmosphere containing less than 1000 ppm (preferably less than 100 ppm) of oxygen.

The preparing method of the stimulable phosphor is further detailed below.

Preparation of a crystalline precipitate of precursor:

Initially, material(s) except for a fluoride compound are dissolved in an aqueous medium. Thus, BaX₂ (BaBr₂, BaI₂) and a halide of Ln (and if necessary, a halide of M¹) are each added into an aqueous solvent and dissolved with stirring to prepare an aqueous solution. In this case, the amounts of Ba X₂ (BaBr₂, BaI₂) and the aqueous solvent are pre-adjusted so as to have 0.25 mol/l or more of a concentration of Ba X₂ (BaBr₂, BaI₂). A small amount of acid, ammonia, alcohol, water-soluble polymer or fine grained powder of water-insoluble metal oxide may be added thereto. The solution (reaction mother liquor) is maintained at 50° C.

Next, into the reaction mother liquor maintained at 50° C. with stirring, an aqueous solution of an inorganic fluoride (such as ammonium fluoride or alkaline metal fluoride is introduced through a pipe provided with a pump. The aqueous solution is preferably introduced to a portion in which stirring is vigorously performed. Introduction of the fluoride aqueous solution into the reaction mother liquor results in precipitation of precursor crystals.

The resulting crystals of the phosphor precursor are separated from the solution through filtration or centrifugation, washed sufficiently with liquid such as methanol and then dried. To the dried crystals of the phosphor precursor is added an anti-sintering agent such as fine alumina powder or fine silica powder, which adheres to the surface of the crystals. It is possible to save addition of the anti-sintering agent by selecting the calcination conditions.

Calcination of Phosphor Precursor

Further, the phosphor precursor crystals are charged into a heat-resistant vessel such as a silica port, an alumina crucible or a silica crucible and then placed in the core portion of an electric furnace to be calcined, without causing the crystals to sinter. The furnace core of an electric furnace is limited to those in which the atmosphere is replaceable during calcination. Preferably employed as the furnace is a moving bed type electric furnace, such as a rotary kiln.

After charging the stimulable phosphor precursor into the furnace core, the atmosphere in the core of the furnace is replaced by a weakly reducing atmosphere containing oxygen of less than 1000 ppm (preferably less than 100 ppm). The weakly reducing atmosphere is a hydrogen/nitrogen gas mixture containing hydrogen of not more than 5% (more preferably 0.1 to 3%). Reducing power can be obtained at a hydrogen concentration of not less than 0.1%, resulting in enhanced emission characteristics and the concentration of not more than 5% is preferred in handling, preventing reduction of the stimulable phosphor crystals.

Prior to atmosphere replacement, the atmosphere in the core may be evacuated, for example, using a rotary evacuation pump. The evacuation improves atmosphere-replacing efficiency. In cases when replacing the atmosphere without evacuation (so-called forced replacement), it is necessary to introduce an atmosphere of at least 3 times the core volume.

After replacing the atmosphere in the core with the atmosphere described above, heating to 600° C. or higher is conducted, thereby leading to enhanced emission characteristics. During the period from the start of heating to taking-out the stimulable phosphor, the mixed atmosphere in the core is preferably allowed to flow at a flow rate of at least 0.1 l/min (more preferably 1.0 to 5.0 l/min). Thereby, the atmosphere in the furnace core is replaced and reaction products produced in the core other than a stimulable phosphor are removed. Specifically, in cases where the reaction products contain an iodide, yellowing of the stimulable phosphor due to the iodide and deterioration of stimulated emission due to yellowing can be prevented. The heating rate, depending on the material of the core pipe, the amount of precursor crystals and specification of the electric furnace, is preferably from 1 to 50° C./min.

After reaching 600° C. or more, oxygen is introduced, in which the percentage by volume of the oxygen is less than that of a reducing component, based on the total volume of the atmosphere and the atmosphere is further maintained for a period of at least 1 min., in which the temperature is preferably from 600 to 1300° C., and more preferably from 700 to 1000° C. At a temperature of 600° C. or more, superior stimulated emission characteristics can be achieved, and at a temperature of 700° C. or more can be obtained preferred stimulated emission characteristics for radiographic diagnosis. Further, at a temperature of 1300° C. or less can be prevented larger particle formation due to sintering, and specifically at a temperature of 1000° C. or less can be obtained a stimulable phosphor with preferred particle size for radiographic diagnosis. More preferably the temperature is in the vicinity of 820° C. In this case, the atmosphere replacement is performed under forced flow, and the weakly reducing atmosphere newly introduced is preferably a mixed gas comprised of not more than 5% by volume of hydrogen, oxygen less than the hydrogen and nitrogen as the remainder. More preferably, the mixed gas is comprised of 0.1 to 3% hydrogen, oxygen with a concentration of 40 to 80% of the hydrogen and nitrogen as the remainder. Still more preferably, the mixed gas is comprised of 1% of hydrogen, 0.6% of oxygen and the remainder of nitrogen. At a hydrogen concentration of not less than 0.1% is obtained the reducing power, leading to enhance emission characteristics. Further, the hydrogen concentration of not more than 5% is preferred for handling, preventing crystals of the stimulable phosphor from being reduced. Furthermore, the oxygen concentration within the range above described enhances the stimulated emission intensity, and specifically at a concentration of 60% of the hydrogen, the emission intensity is markedly enhanced. In this case, oxygen may be introduced into the furnace core atmosphere during heating, wherein the mixing ratio can be adjusted by the ratio of the flow rate of hydrogen/nitrogen mixed gas to that of oxygen. In place of oxygen, an atmosphere may be introduced as it is. Furthermore, the ratio of the flow rate of an oxygen/nitrogen-mixed gas to that of hydrogen/nitrogen-mixed gas may be adjusted.

Until reaching the desired mixing ratio of nitrogen, hydrogen and oxygen, a new atmosphere of at least 3 times the volume of the furnace core is preferably introduced. Further for at least 1 min., and preferably for 1 to 60 min., the mixed atmosphere of nitrogen, hydrogen and oxygen is maintained at a temperature of not less than 600° C.

The stimulable phosphor is thus obtained according to the calcination described above.

The stimulable phosphor preferably has an average particle size of 0.8 to 15 μm, more preferably 1 to 10 μm, and still more preferably 1 to 8 μm.

Preparation of Radiographic Image Conversion Panel

As supports used in the radiographic image conversion panel according to the invention are employed a various types of polymeric material, glass and metals. Materials which can be converted to a flexible sheet or web are particularly preferred in handling as a information recording material. From this point, there are preferred plastic resin films such as cellulose acetate films, polyester films, polyamide films, polyimide films, triacetate films or polycarbonate films; metal sheets such as aluminum, iron, copper or chromium; or metal sheets having a said metal oxide covering layer.

A thickness of the support depends on properties of the material, and is generally 10 to 1000 μm and preferably 10 to 500 μm in terms of handling. The surface of the support may be glossy or may be matte for the purpose of enhancing adhesiveness to a stimulable phosphor layer. The support may be provided with a subbing layer under the stimulable phosphor layer for the purpose of enhancing adhesiveness to the phosphor layer.

Examples of binders used in the stimulable phosphor layer according to the invention include proteins such as gelatin, polysaccharide such as dextran, natural polymeric materials such as arabic gum and synthetic polymeric materials such as polyvinyl butyral, polyvinyl acetate, nitrocellulose, ethylcellulose, vinylidene chloride/vinyl chloride copolymer, polyalkyl (metha)acrylate, vinyl chloride/vinylacetate copolymer, polyurethane, cellulose acetate butyrate, polyvinyl alcohol and linear polyester. Of these binders are preferred nitrocellulose, linear polyester, polyalkyl (metha)acrylate, a mixture of nitrocellulose and linear polyester, a mixture of nitrocellulose and polyalkyl (metha)acrylate and a mixture of polyurethane and polyvinyl butyral. The binder may be cured with a cross-linking agent.

The stimulable phosphor layer can be coated on a subbing layer, for example, according to the following manner. Thus, an iodide-containing stimulable phosphor, a compound such a phosphite ester for preventing yellow stain and binder are added into an optimal solvent to prepare a coating solution in which phosphor particles and particles of the compound(s) are uniformly dispersed in a binder solution.

The binder is employed in an amount of 0.01 to 1 part by weight per 1 part by weight of the stimulable phosphor. A smaller amount of the binder is preferred in terms of sensitivity and sharpness of the radiographic image conversion panel and a range of 0.03 to 0.2 parts by weight is preferred in terms of easiness of coating.

A ratio of the binder to the stimulable phosphor (with the proviso that in the case of all of the binder being an epoxy group-containing compound, the ratio is that of the compound to the phosphor) depends on characteristics of the objective radiographic image conversion panel, the kind of the phosphor and an addition amount of the epoxy group-containing compound. Examples of solvents used for preparing the coating solution include lower alcohols such as methanol, ethanol, 1-propanol, 2-propanol, and n-butanol; chlorine-containing hydrocarbons such as methylene chloride and ethylene chloride; ketones such as acetone, methyl ethyl ketone, methyl isobutyl ketone; esters of a lower fatty acid and lower alcohol such as methyl acetate, ethyl acetate and butyl acetate; ethers such as dioxane, ethylene glycol ethyl ether and ethylene glycol monomethyl ether; toluene; and a mixture thereof.

There may be incorporated, in the coating solution, a variety of additives, for example, a dispersing agent for improving dispersibility of the phosphor in the coating solution. Examples of the dispersing agent include phthalic acid, stearic acid, caproic acid and oleophilic surfactants. Examples of the plasticizer include phosphate esters such as triphenyl phosphate, tricresyl phosphate and diphenyl phosphate; phthalate esters such as diethyl phthalate, dimethoxyethyl phthalate; glycolic acid esters such as ethylphthalyethyl glycolate and dimethoxyethyl glycolate; and polyesters of polyethylene glycol and aliphatic dibasic acid such as polyester of triethylene glycol and adipinic acid, and polyester of diethylene glycol and succinic acid.

The coating solution as prepared above was uniformly coated on the surface of the subbing layer to form a coating layer. Coating can be carried out by conventional coating means, such as doctor blade, roll coater and knife coater. The coating solution of the stimulable phosphor layer can be prepared by using a dispersing apparatus, such as a ball mill, sand mill, atriter, three-roll mill, high-speed impeller, Kady mill and ultrasonic homogenizer. The prepared coating solution is coated on a support by using a doctor blade, roll coater or knife coater and dried to form the stimulable phosphor layer. After the above coating solution may be coated on a protective layer and dried, the stimulable phosphor layer may be adhered to the support. The thickness of the stimulable phosphor layer, depending of characteristics of the radiographic image conversion panel, the kind of stimulable phosphors and the mixing ratio of a binder to phosphor, is preferably 10 to 1,000 μm, and more preferably 10 to 500 μm.

A phosphor sheet which is comprised of a support provided thereon with a phosphor layer, is cut to a prescribed size. Cutting can be performed in any way and desirably using a trimming cutter or a punching machine in terms of workability and precision. Phosphor sheets which have been cut to a prescribed size are sealed with a moisture-resistant protective film. Examples of a sealing method include a method in which a phosphor sheet is sandwiched up and down between moisture-resistant protective films and the peripheral area is thermally sealed using an impulse sealer and a system of laminating between heated rollers with applying pressure and heating. When thermally sealed using a impulse sealer, sealing under reduced pressure is preferred to prevent slippage within a moisture-resistant protective film or exclude atmospheric moisture.

### EXAMPLES

The present invention will be further described based on examples but embodiments of this invention are by no means limited to these examples.

### Example 1

To synthesize a precursor of europium activated barium fluoroiodide stimulable phosphor, 2500 ml of an aqueous BaI₂ solution (1.75 mol/l) and 125 ml of an aqueous EuI₃ solution (0.067 mol/l) were introduced into a reactor vessel. Reaction mother liquor in the reactor vessel was maintained at a temperature 83° C. with stirring. Using a roller pump, 250 ml of an aqueous ammonium fluoride solution (8 mol/l) was added into the reaction mother liquor to form a precipitate. After completion of the addition, the reaction mixture was further stirred for 2 hrs. with maintaining the temperature to conduct ripening of the precipitate. Next, the precipitate was filtered, washed with methanol and dried under evacuation to obtain crystalline europium activated barium fluoroiodide. The obtained crystal was charged into a silica boat and then calcined in a hydrogen gas atmosphere using a tube furnace at 850° C. for 2 hr. to obtain europium activated barium fluoroiodide phosphor particles.

Then, the obtained phosphor particles were subjected to a surface treatment using a fluorine-containing compound and a silane coupling agent, as shown in Table 1, in which the fluorine-containing compound was a fluorine-containing polymer formed of a monomer or repeating unit, as shown in Table 1. The surface treatment for the phosphor particles was conducted in the manner that 300 g of phosphor particles was put into 150 ml of a solvent mixture of methyl perfluoroisobutyl ether and methyl perfluorobutyl ether (available from Sumitomo-3M Co.) and thereto, a fluorinated polymer was dropwise added with stirring by a Henschel mixer.

To a solvent mixture of methyl ethyl ketone and toluene (1:1) were added 427 g of the foregoing europium activated barium fluoroiodide phosphor particles, 15.8 g of polyurethane resin (DESMOLAC 4125, available from Sumitomo-Bayer Urethane Corp.) and 2.0 g of bisphenol A-type epoxy resin and dispersed by a propeller mixer to obtain a coating solution having a viscosity of 1.84 to 2.21 W. The coating solution was coated on a polyethylene terephthalate film support and dried at 100° C. for 15 min. to form a 230 μm thick phosphor layer. The thus prepared coating samples were each cut to a square of 10 cm×10 cm to obtain radiation image conversion panels having a stimulable phosphor layer.

The thus prepared samples were allowed to stand in an environment of 30° C. and 80% R.H. for 4 days. The sensitivity ratio of an aged sample to a fresh sample was determined as a measure of moisture resistance. A value closer to 1 indicates less deterioration. The respective values were represented by an average value of 10 times sampling. Sensitivity was determined in the manner that radiation image conversion panel samples were each exposed to X rays at a tube voltage of 80 kVp and then stimulated by scanning with He—Ne laser (633 nm), in which stimulated light emitted from the stimulable phosphor layer was detected by a photoreceptor (i.e., a photoelectron multiplier having spectral sensitivity of S-5) to measure its intensity. Sensitivity was represented by a relative value, based on the sensitivity of fresh sample of example 1 being 1.0.

TABLE 1

| | | Silane | | | | |
|---|---|---|---|---|---|---|
| | | Coupling | Sensitivity | | | |
| Sample | Fluorine-containing Compound | Agent | Fresh | Aged | Moisture | |
| No. | (wt %) | (wt %) | Sample | Sample | Resistance | Remark |
| 1 | -(−) | — | 1.00 | 0.08 | 0.08 | Comp. |
| 2 | -(−) | a(2.0) | 1.15 | 0.35 | 0.30 | Comp. |
| 3 | F(CF₂)₆CH₂(═O)C(CH₃)═CH₂(2.0) | — | 1.50 | 0.43 | 0.28 | Comp. |
| 4 | F(CF₂)₆CH₂(═O)C(CH₃)═CH₂(2.0) | b(2.0) | 1.55 | 1.50 | 0.96 | Inv. |
| 5 | F(CF₂)₆CH₂(═O)C(CH₃)═CH₂(2.0) | a(2.0) | 1.57 | 1.57 | 1.00 | Inv. |
| 6 | F(CF₂)₆CH₂(═O)C(CH₃)═CH₂(0.1) | a(0.1) | 1.38 | 0.85 | 0.61 | Inv. |
| 7 | F(CF₂)₆CH₂(═O)C(CH₃)═CH₂(25.0) | a(25.0) | 0.97 | 0.97 | 1.00 | Inv. |
| 8 | c-C₆F₁₁OC(═O)C(CH₃)—CH₂(2.0) | a(2.0) | 1.56 | 1.56 | 1.00 | Inv. |
| 9 | c(2.0) | a(2.0) | 1.52 | 1.51 | 0.99 | Inv. |

a: γmercaptopropyltrimethoxysilane
b: Oglycidoxypropyltrimethoxysilane
c: fluorinated polymer comprising the following repeating unit

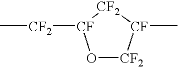

As apparent from Table 1, it was proved that inventive phosphor sheet samples exhibited minimized deterioration in sensitivity due to moisture absorption. Coating the phosphor particles with a silane coupling agents resulted in tendency of enhancing sensitivity (fresh samples) and it is contemplated that the fluorine-containing compound caused no trouble occurred in the pulverizing dispersing and coating processes.

### Example 2

To synthesize a precursor of europium activated barium fluoroiodide stimulable phosphor, 2500 ml of an aqueous BaI₂ solution (3.5 mol/l) and 125 ml of an aqueous EuI₃ solution (0.2 mol/l) were introduced into a reactor vessel. Reaction mother liquor in the reactor vessel was maintained at a temperature 83° C. with stirring. Using a roller pump, 250 ml of an aqueous ammonium fluoride solution (8 mol/l) was added into the reaction mother liquor to form a precipitate. After completion of the addition, the reaction mixture was further stirred for 2 hrs. with maintaining the temperature to conduct ripening of the precipitate. Then, the precipitate was filtered, washed with methanol and dried under evacuation to obtain crystalline europium activated barium fluoroiodide. Next, a first particulate metal oxide shown in Table 2 was added thereto and sufficiently stirred by a mixer so that the particulates adhered onto the surface of the phosphor precursor particles. The mixture was charged into a silica boat and then calcined in a hydrogen gas atmosphere using a tube furnace at 850° C. for 2 hr. to obtain europium activated barium fluoroiodide phosphor particles having an average size of 3 μm.

Next, a second particulate metal oxide shown in Table 2 and the foregoing europium activated barium fluoroiodide phosphor particles were sufficiently mixed by a mixer so that the particulate metal oxide adhered onto the surface of the phosphor precursor particles. Subsequently, using a spray nozzle, a dispersion of a fluorine-containing compound and a silane coupling agent were uniformly sprayed into the phosphor particles and dried. The second particulate metal oxides, fluorine-containing compounds and silane coupling agents were used as shown in Table 2. Drying was conducted at 80° C. for 24 hrs. As shown in Table 2, the following second particulate metal oxides, fluorine-containing compounds and silane coupling agents were used.

A1: particulate alumina

A2: particulate silica

B1: γ-mercaptopropyltrimethoxysilane

B2: vinyl triethoxysilane

C1: polymer formed of monomer F(CF₂)₆CH₂OC(═O)C(CH₃)═CH₂

C2: polymer having a repeating unit as below:

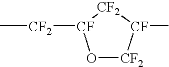

Radiation image conversion panels were prepared in a similar manner to Example 1. The thus prepared samples were each cut to a square of 10 cm×10 cm and sealed into a barrier bag having aluminum foil laminated onto the back to obtain radiation image conversion panel samples 1 to 11.

The thus prepared samples were allowed to stand in an environment of 30° C. and 80% R.H. for 10 days. The sensitivity ratio of an aged sample to fresh sample was determined. A value closer to 1 indicates less deterioration. Sensitivity was determined in a similar manner as described earlier. Sensitivity was represented by a relative value, based on the sensitivity of fresh sample 11 being 1.0. Results are shown in Table 2.

TABLE 2

| | First | Second | Fluorine- | Silane | | | |
|---|---|---|---|---|---|---|---|
| | Metal | Metal | containing | Coupling | Sensitivity | | |
| Sample | Oxide | Oxide | Compound | Agent | (Fresh | Moisture | |
| No. | (wt %) | (wt %) | (wt %) | (wt %) | Sample) | Resistance | Remark |
| 1 | −(0.0) | −(0) | −(0.0) | −(0.0) | 1.00 | 0.00 | Comp. |
| 2 | A1(0.5) | A2(1.0) | −(0.0) | B1(1.0) | 1.32 | 0.40 | Comp. |
| 3 | A1(0.5) | A2(1.0) | C1(1.0) | B1(1.0) | 1.60 | 0.99 | Inv. |
| 5 | A1(0.002) | A2(0.006) | C1(1.0) | B1(l.0) | 1.12 | 0.75 | Inv. |
| 6 | A1(4.0) | A2(7.0) | C1(6.0) | B1(5.0) | 0.85 | 0.98 | Inv. |
| 7 | A2(0.5) | A1(1.0) | C1(1.0) | B1(1.0) | 1.55 | 0.92 | Inv. |
| 8 | A1(0.5) | A1(1.0) | C1(1.0) | B1(1.0) | 1.53 | 0.94 | Inv. |
| 9 | A1(0.5) | A2(l.0) | C1(1.0) | B2(1.0) | 1.56 | 0.95 | Inv. |
| 10 | A1(0.5) | A2(1.0) | C2(1.0) | B1(1.0) | 1.58 | 0.97 | Inv. |
| 11 | A1(0.5) | A2(1.0) | C1(0.01) | B1(0.01) | 1.40 | 0.85 | Inv. |

As apparent from Table 2, it was proved that covering the phosphor particles with a first particulate metal oxide and after calcination, covering the calcined phosphor particles with a second particle metal oxide, a flourine-containing compound and a silane coupling agent obtained a stimulable phosphor exhibiting enhanced sensitivity and superior moisture resistance. Covering the phosphor particles with a particulate metal oxide tended to result in enhanced sensitivity (fresh samples) and it is contemplated that the particulate metal oxide protected stimulable phosphor particles from troubles occured in the dispersing and coating processes. Such a tendency was marked when particulate silica was used as a second metal oxide.

What is claimed is:

1. A process for preparing stimulable phosphor particles comprising the steps of:
(a) preparing particles of a precursor of the stimulable phosphor,
(b) subjecting the particles of the precursor to calcination to obtain stimulable phosphor particles, and
(c) coating the stimulable phosphor particles with a fluorine-containing compound and a silane coupling agent.

2. The process of claim 1, wherein the stimulable phosphor particles are a rare earth activated alkaline earth metal fluorohalide phosphor represented by the following formula (I):
(Ba₁₋ₓM¹ₓ)FX:yM², zLn formula (I)
wherein M¹ is at least one alkaline earth metal selected from the group consisting of Mg, Ca, Sr, Zn and Cd; M² is at least one alkali metal atom selected from the group consisting of Li, Na, K, Rb and Cs; X is at least one halogen atom selected from the group consisting of Cl, Br and I; Ln is at least one rare earth element selected from the group consisting of Ce, Pr, Sm, Eu, Gd, Tb, Tm, Dy, Ho, Nd, Er and Yb; x, y and z are respectively 0≦x≦0.6, 0≦y≦0.05 and 0≦z≦0.2.

3. The process of claim 1, wherein the silane coupling agent is a mercapto group-containing silane coupling agent.

4. The process of claim 3, wherein the mercapto group-containing silane coupling agent is γ-mercaptopropyl-trimethoxysilane or γ-mercaptopropylmethyldimethoxysilane.

5. The process of claim 1, wherein the fluorine-containing compound is a fluorine-containing polymer dissolved in a fluorinated solvent.

6. The process of claim 1, wherein the fluorine-containing compound is coated in an amount of 0.2% to 20% by weight, based on the stimulable phosphor.

7. The process of claim 1, wherein the silane coupling agent is coated in an amount of 0.2% to 20% by weight, based on the stimulable phosphor.

8. The process of claim 1, wherein step (a) further comprises coating the particles of the precursor with a first particulate metal oxide having an average particulate size of 2 to 50 nm.

9. The process of claim 1, wherein in step (c), a second particulate metal oxide having an average particulate size of 2 to 50 nm is coated together with the fluorine-containing compound and the silane coupling agent.

10. The process of claim 9, wherein a total amount of the first metal oxide and the second metal oxide is 0.01% to 10% by weight based on the stimulable phosphor and a total amount of the fluorine-containing compound and the silane coupling agent is 0.01% to 10% by weight based on the stimulable phosphor.

11. The process of claim 8, wherein the first metal oxide is alumina.

12. The process of claim 9, wherein the second metal oxide is silica.

13. A stimulable phosphor, wherein the stimulable phosphor is comprised of stimulable phosphor particles prepared by a process, as claimed in claim 1.

14. The stimulable phosphor of claim 13, wherein the stimulable phosphor is a rare earth activated alkaline earth metal fluorohalide phosphor represented by the following formula (I):
(Ba₁₋ₓM¹ₓ)FX:yM², zLn formula (I)
wherein M¹ is at least one alkaline earth metal selected from the group consisting of Mg, Ca, Sr, Zn and Cd; M² is at least one alkali metal atom selected from the group consisting of Li, Na, K, Rb and Cs; X is at least one halogen atom selected from the group consisting of Cl, Br and I; Ln is at least one rare earth element selected from the group consisting of Ce, Pr, Sm, Eu, Gd, Tb, Tm, Dy, Ho, Nd, Er and Yb; x, y and z are respectively 0≦x≦0.6, 0≦y≦0.05 and 0≦z≦0.2.

15. The stimulable phosphor of claim 13, wherein the silane coupling agent is a mercapto group-containing silane coupling agent.

16. The stimulable phosphor of claim 15, wherein the mercapto group-containing silane coupling agent is γ-mercaptopropyl-trimethoxysilane or γ-mercaptopropylmethyldimethoxysilane.

17. The stimulable phosphor of claim 13, wherein the fluorine-containing compound is a fluorine-containing polymer dissolved in a fluorinated solvent.

18. The stimulable phosphor of claim 13, wherein the fluorine-containing compound is coated in an amount of 0.2% to 20% by weight, based on the stimulable phosphor.

19. The stimulable phosphor of claim 13, wherein the silane coupling agent is coated in an amount of 0.2% to 20% by weight, based on the stimulable phosphor.

20. A radiation image conversion panel comprising a support having thereon a phosphor layer containing a binder and stimulable phosphor particles, wherein the stimulable phosphor particles are prepared by a process, as claimed in claim 1.
